(19) United States
(12) Patent Application Publication
(10) Pub. No.: US 2026/0195657 A1
(43) Pub. Date: Jul. 9, 2026

(54) Collective Voting to Predict Bit Wear

(71) Applicants: Saudi Arabian Oil Company, Dhahran (SA); Baker Hughes Oilfield Operations LLC, Houston, TX (US)

(72) Inventors: Guodong Zhan, Dhahran (SA); Mahmoud Abughaban, Dhahran (SA); Xu Huang, The Woodlands, TX (US); Trieu Phat Luu, The Woodlands, TX (US); Yazeed S. Qahtani, Dhahran (SA); John Bomidi, The Woodlands, TX (US)

(21) Appl. No.: 19/013,950

(22) Filed: Jan. 8, 2025

(51) Int. Cl. G06N 20/20

(52) U.S. Cl. CPC G06N 20/20

(57) ABSTRACT

A computer implemented method that enables collective voting from an ensemble model to predict bit wear is described. The method includes obtaining input data from a target well in real-time by an ensemble model. At least one physics-based model and at least one trained artificial intelligence model are applied to the input data to generate bit wear predictions. A collective voting scheme is applied to the bit wear predictions to obtain a final bit wear prediction. Drilling operations are updated responsive to the final bit wear prediction.

### TECHNICAL FIELD

This disclosure relates generally to hydrocarbon exploration, drilling, and production, and more particularly, to predicting bit wear.

### BACKGROUND

During drilling, wear components can degrade or fail. For example, drill bits break and otherwise degrade during drilling. When a drill bit wears out or fails, the drill string is removed from the borehole, the drill bit replaced, and then drilling resumes. Drill bit wear is often not immediately observable.

### BRIEF DESCRIPTION OF DRAWINGS

FIG. 1 shows a workflow for collective voting from an ensemble model to predict bit wear.

FIG. 2 is a process flow diagram of a process that enables collective voting to predict bit wear.

FIG. 3 illustrates hydrocarbon production operations that include both one or more field operations and one or more computational operations, which exchange information and control exploration for the production of hydrocarbons.

FIG. 4 is a partial schematic perspective view of an example rig system for drilling and producing a well.

FIG. 5 is a schematic illustration of an example controller (or control system) for that enables a training an artificial intelligence model to predict bit wear.

### DETAILED DESCRIPTION

During drilling a drill bit is a tool used to cut, shear, crush, or otherwise displace rock of a formation. During drilling operations, drilling data associated with a target well is captured. The drilling data is used by various models to predict drill bit wear. In some embodiments, physics-based models are used to predict bit wear. In some embodiments, artificial intelligence models such as machine learning models are used to predict bit wear. The physics-based models and artificial intelligence based models are configured in an ensemble model. Input data is obtained by the ensemble model, where each respective physics-based model and each respective artificial intelligence based model generates a bit wear prediction. A collective voting scheme is applied to the bit wear predictions to obtain a final bit wear prediction. The ensemble model takes advantage of both physics-based model and machine learning model to reduce field data noise and increases model accuracy.

Conventional methods include manual bit wear estimation. However, human estimates of bit wear can be highly subjective and convoluted by changes in formation and drilling data. In real-time drilling operations, replacing the drill bit includes tripping out the bit from the bottom of the hole to the surface. The bit is disconnected from the drill string and replaced with a new (e.g., sharp) drill bit. The new drill bit is connected to the drill string and inserted in the hole for further drilling operations. Tripping out the bit is time consuming and causes a pause in drilling operations. However, drilling with a suboptimal rate of penetration is also costly.

While human learning can subjectively pick up the indicators that are in rig surface data streams, this information is highly convoluted with changes in rock and drilling data. Models that predict bit wear, such as physics-based models or artificial intelligence models, are often limited to the training data available when the models were built. Further, the models can experience stability issues due to field data noise. The present techniques apply physics-based models and trained artificial intelligence models to input data obtained from a target well. A collective voting scheme mitigates any limitations of a single model, enabling a more robust prediction of bit wear.

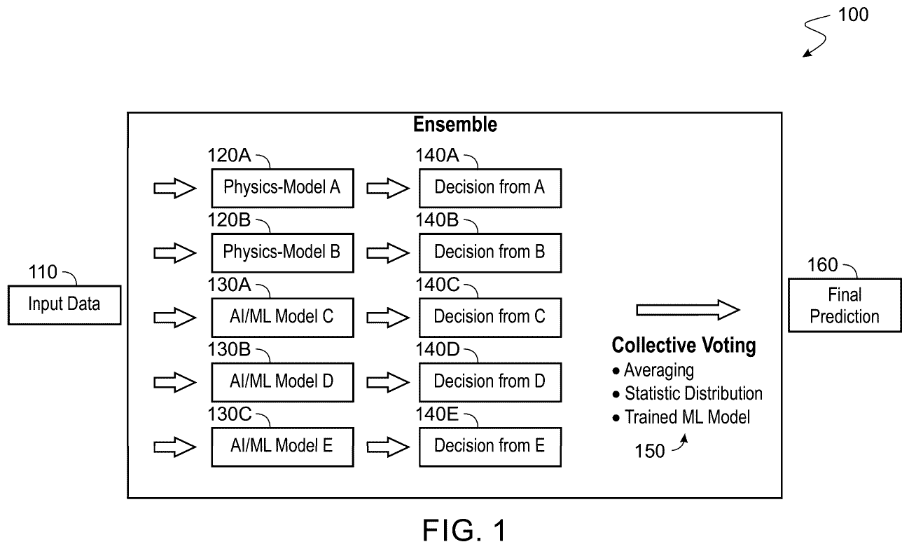

FIG. 1 shows a workflow for collective voting from an ensemble model to predict bit wear. In examples, drill bits work by scraping or crushing the rock, or both, as a part of a rotational motion. In examples, the drill bits are hammer bits, and pound the rock vertically to displace the rock. Over time, drill bits will become damaged, worn, eroded, or excessively dull. If the bit has enough wear, the bit will stop making process through the formation. In examples, a drill bit is located at the bottom end of a drill string and is changed when it becomes excessively dull or stops making process through the formation. At least one physics based model and at least one trained artificial intelligence model are used to predict bit wear. In some embodiments, the bit wear predictions are weighted based on, at least in part, a training accuracy associated with a respective model. The artificial intelligence model is trained to predict the wear on a drill bit, such as how damaged, worn, or eroded the drill bit has become over time.

FIG. 1 shows input data 110. In examples, the input data is drilling data obtained in real-time. In examples, the input data includes surface drilling data, and downhole logging data. Surface drilling data includes weight on bit (WOB), rate of penetration (ROP), rotations per minute (RPM), flow rate, and the like. Downhole logging data includes density, gamma, porosity, and the like. In some embodiments, the input data is real-time data from a drilling rig to enable real-time predictions from the models 120 and 130. Drilling data can be obtained from many sources, such as sensors, logs, cores, and tests. In examples, sensors measure physical parameters, such as pressure, temperature, torque, and vibration, during drilling. Logs are records of the properties of the formations and fluids encountered by the drill bit at various depths, such as resistivity, porosity, and density. Cores are cylindrical samples of the rock at various depths. The cores are extracted from the borehole for further analysis. Tests are experiments that are performed on the wellbore, the formation, or the fluids to obtain information about their characteristics and behavior.

The input data 110 is input to the ensemble model 100. The input data 110 is processed before being input to the ensemble model 100. In examples, preprocessing applied to the input data 110 includes filling in missing data and removing outliers. In examples, the processing includes transforming the input data 110 to a standard data format. In some embodiments, the input data is synchronized according to depth. Additionally, in some embodiments, the input data is synchronized according to time. Accordingly, depth-based data or time-based data synchronized with other measurements such as WOB, RPM, torque, and the like is available in real-time. The ensemble model includes a physics based model 120A and a physics based model 120B (collectively referred to as physics based models 120). The ensemble model also includes an artificial intelligence based model 130A, an artificial intelligence based model 130B, and an artificial intelligence based model 130C (collectively referred to as artificial intelligence based models 130). In examples, the physics based models predict bit wear based on a physics-based wear equation. For example, a physics based wear equation predicts wear on a drill bit as a function of cutting force of a drill bit, cutting distance of a drill bit, temperature of a drill bit, downhole temperature, or any combinations thereof. In examples, parameters of the physics based models are the coefficients of the physics-based wear equation. These parameters are first determined from derivations, lab/field testing, or modeling. When applying the physics-based model to different target wells of different well sections, some model parameters are updated. In examples, when changing from a soft rock to a hard formation, the parameters related to the wear rate are updated to reflect the formation change.

In some embodiments, artificial intelligence models, such as machine learning models, are used in hydrocarbon exploration, drilling, and production. The models are trained to draw conclusions using a collection of data. The conclusions include solving problems, making predictions, classifying input data, and the like. In examples, artificial intelligence models predict bit wear associated with drilling a target well. Each respective artificial intelligence model is trained to optimize the artificial intelligence model parameters to minimize a loss function, which is the difference between the model prediction and real measured value. In some embodiments, the training data is filtered so that the data used to train the artificial intelligence model is from wells with similar features as a target well (e.g., a well being planned or drilled).

In some embodiments, artificial intelligence models 130 predict bit wear associated with drilling a target well. For example, bit wear is predicted when planning a drilling program or during actual drilling operations. The artificial intelligence models are trained using data associated with relevant offset wells. In examples, the artificial intelligence model is trained predict bit wear using filtered data. In particular, filters are used to extract data associated with relevant offset wells, which enables a more robust prediction of bit wear when drilling a target well. Multiple filters are applied to a data pool associated with offset wells, wherein the filters comprise physics-based filters and data driven filters. In examples, physics based filters include a comparison between (1) actual data or predicted data associated with the target well from a physics-based model and (2) obtained data associated with an offset well. In examples, data-driven filters are based on data analysis and interpretation of actual data or predicted associated with the target well and data associated with the offset wells. A first filtered dataset including data associated with a set of offset wells filtered by the physics-based filter is created. Additionally, a second filtered dataset including data associated with a set of offset wells filtered by the data driven filter is created. A training dataset is created from the first filtered dataset and the second filtered dataset. In examples, data associated with a set of offset wells occurring in each of the first filtered dataset and the second filtered dataset (e.g., data associated with relevant offset wells) are used to train at least one artificial intelligence model.

Accordingly, a precisely filtered dataset associated with offset wells forms the training data used to train the artificial intelligence model. This filtered dataset is developed by applying physics based filters and data driven filters to obtain data associated with an offset well. In examples, the artificial intelligence model is trained using the rig data from an offset well associated with a target application (WOB, ROP, RPM, logging and so on). Once it is trained, real-time rig data is input to the trained artificial intelligence for the real-time prediction based on one or more target applications. Subsequently, the predictions from each model are generated and used for voting in real-time. The input data 110 is input to each of the physics based model 120A, physics based model 120B, artificial intelligence based model 130A, artificial intelligence based model 130B, and artificial intelligence based model 130C. The physics based model 120A, physics based model 120B, artificial intelligence based model 130A, artificial intelligence based model 130B, and artificial intelligence based model 130C outputs a bit wear prediction 140A, a bit wear prediction 140B, a bit wear prediction 140C, a bit wear prediction 140D, and a bit wear prediction 140E, respectively (collectively referred to as bit wear predictions 140). A collective voting scheme 150 is applied to the bit wear predictions 140 to obtain a final bit wear prediction 160. For an instance of the ensemble model 100, at least one collective voting scheme is selected. In examples, voting schemes are tested using the offset well data. For example, an even-average voting scheme and weighted voting scheme are compared for the accuracy using the offset data. The voting scheme with a higher accuracy is used for real-time bit-wear predictions, such as bit wear predictions during the drilling of a well. Additionally, in some embodiments, the collective voting schemes described are implemented independently and output a final bit wear prediction 160. In some embodiments, the collective voting schemes are applied to the predictions from multiple models in parallel, and the collective voting schemes generate multiple bit wear predictions. The multiple bit wear predictions are clustered or averaged to obtain a final bit wear prediction 160. In some embodiments, the collective voting schemes are combined to generate a final bit wear prediction 160. For example, an averaging scheme averages bit wear predictions that are Boolean values. An averaging scheme averages predictions of the same or substantially similar depths, resulting in the predictions that are associated with similar depths.

In examples, the collective voting scheme is an averaging scheme. For example, each respective model 120A, 120B, 130A, 130B, or 130C outputs a value that is averaged. In some embodiments, the bit wear predictions are Boolean values that indicate a level of severity of bit wear. In examples, zero (0) represents a new, sharp drill bit, and one (1) represents a dull damaged, or otherwise failed drill bit. The bit wear predictions 140 are averaged according to a collective voting scheme to obtain a final bit wear prediction 160. In an even-average voting scheme, each model has an equal vote on the final bit wear prediction 160. In examples where zero (0) represents a new, sharp drill bit, and one (1) represents a dull damaged, or otherwise failed drill bit, the average of the Boolean values represents the proportion of models that predict a dull damaged, or otherwise failed drill bit. For example, when four models output Boolean values of [1, 0, 1, 1], the average is as follows:

$$Average = \frac{1 + 0 + 1 + 1}{4} = 0.75$$

The average of these Boolean values is 0.75, indicating that 75% of the models predict a dull damaged, or otherwise failed drill bit. In some embodiments, when the average of models that predict a dull damaged, or otherwise failed drill bit is above a predetermined threshold, the final bit wear prediction 160 is that the drill bit is dull damaged, or otherwise failed. In some embodiments, the predetermined threshold is 50% or greater.

In some embodiments, the collective voting scheme is an average of the bit wear predictions according to depth. In examples, each of the physics based models and the artificial intelligence models output a respective bit wear prediction at various depths of a target well being drilled. For a drilled interval of the target well, bit wear predictions from a physics based model or an artificial intelligence model within the interval are averaged. For example, bit wear predictions from physics based models 120 or artificial intelligence based models 130 at depths within 100 ft intervals are averaged to obtain a final bit wear prediction 160 corresponding to the interval. For ease of description, a predetermined interval of 100 ft is described. However, intervals of any size can be used according to the present techniques. In examples, bit wear predictions from the physics based models 120 or the artificial intelligence based models 130 are output at depths at within intervals corresponding to known layers of the subsurface. The predictions are averaged to obtain a final bit wear prediction 160 for a well being drilled.

In some embodiments, the collective voting scheme adaptively averages the bit wear predictions based on a granularity of predictions from the physics based models 120 or the artificial intelligence based models 130 according to depth. Granularity of bit wear predictions refers to the scale or level of detail present in bit wear predictions from a respective bit wear model. In examples, a granularity of bit wear predictions describes the frequency at which the predictions occur according to depth. In examples, for each prediction from the physics based models 120 or the artificial intelligence based models 130, remaining predictions at the same or similar depths are averaged to obtain a final bit wear prediction 160 for a well being drilled. In some embodiments, similar depths are two or more bit wear predictions at or near a same depth. For example, consider bit wear predictions from physics based models 120 that occur at every foot (1 ft) of depth, and bit wear predictions from artificial intelligence based models 130 that occur at every five feet (5 ft) of depth. Similar depths of bit wear predictions from physics based models 120 and bit wear predictions from artificial intelligence based models 130 occur at every 5 ft of depth. Accordingly, multiple predictions are available from the physics based models 120 and artificial intelligence based models 130 at depths that are multiples of 5, such as 5 ft, 10 ft, 15 ft . . . and so on. In this example, a similar depth does not occur at 12 ft. Bit wear predictions at similar depths are averaged to obtain a final bit wear prediction 160.

In some embodiments, the collective voting scheme is a weighted average voting scheme. In examples, the bit wear predictions are weighted according to a training accuracy associated with a respective model. For example, an artificial intelligence models are trained using data associated with relevant offset wells. Bit wear predictions output by an artificial intelligence model trained using data associated with relevant offset wells are considered high accuracy when compared with models trained using other data. Bit wear predictions output by an artificial intelligence model trained using data associated with relevant offset wells are weighted higher than bit wear predictions from models trained using other data. In some embodiments, the bit wear predictions are weighted prior to applying a collective voting scheme to the bit wear predictions.

In some embodiments, the bit wear predictions are a statistical distribution of a drill bit being either (1) suitable for drilling or (2) worn and ready for replacement. In some embodiments, the collective voting scheme is a statistical distribution of the bit wear predictions. a bit wear prediction is a statistical distribution of a likelihood that a bit is worn as output by the physics based models 120 or the artificial intelligence based models 130. In examples, the likelihood that the bit is worn is given according to a dull grading. In examples, a dull grade is represented by two numbers: the first number is an averaged inner cutter dull grade, and the second number is an averaged outer cutter dull. The numbers represent the dull value, such as 1, 2, 3, 4 . . . 8 and the like. Dullness of the cutters of a bit increases with the dull value. For example, the dull grading 1-2 indicates that the averaged inner cutter (small radius) of a bit is assigned a value of 1.0 and the averaged outer cutter of a bit dull is assigned a value of 2.0. In examples, number 4 indicates that half of a respective cutter has been worn. Number 8 indicates that a respective cutter is completely worn.

For example, consider an ensemble model including a number of physics based models and a number of artificial intelligence based models, with ten total models included in the ensemble model. Four of the ten models predicts bit wear 1-1. Two of the ten models predicts bit wear 0-1, another two of the ten models predicts bit wear 1-2, and one model predicts bit wear 2-2, and one model predicts bit wear 0-0. The predictions are plotted, and the final bit wear prediction is 1-1, with the highest probability.

In some embodiments, the collective voting scheme is a linear regression. Consider an ensemble model including five models, and each model predicts a dull grade. A linear regression model is fit using the output of the five models to predict the final dull of the bit. For example, consider a linear regression where K indicates the number of factors, regression coefficients, or latent variables of the regression model. The linear regression model is fit using the output of the five models to predict the final dull of the bit as follows:

$${K}_{A} * {Dull}_{Model A} + {K}_{B} * {Dull}_{Model B} + {K}_{C} * {Dull}_{Model C} + {K}_{D} * {Dull}_{Model D} + {K}_{E} * {Dull}_{Model E}$$

For each prediction model, the regression coefficients are fit to the K linear regression coefficients using data from offset wells.

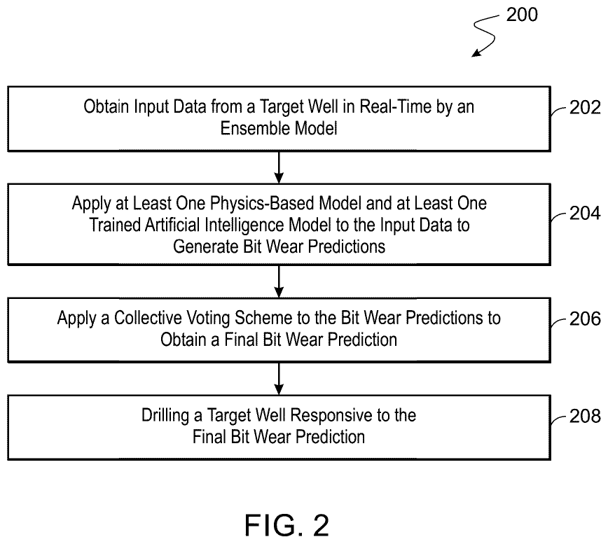

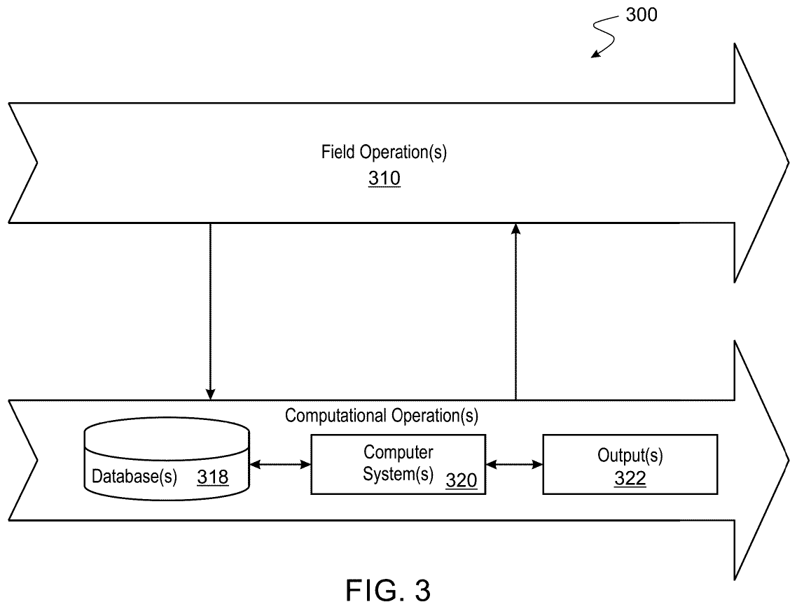

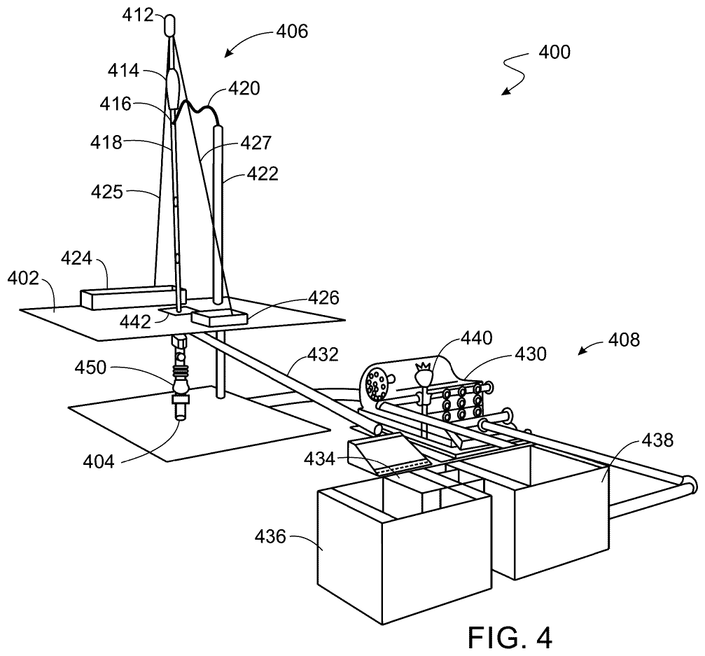

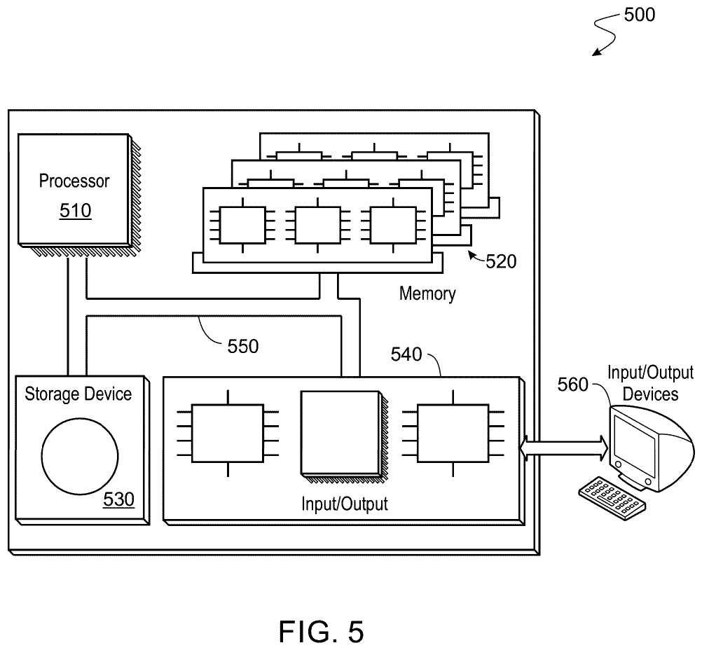

FIG. 2 is a process flow diagram of a process 200 that enables collective voting from an ensemble model to predict bit wear. The process flow diagram 200 can govern the hydrocarbon production operations 300 of FIG. 3. In some embodiments, the data captured during the hydrocarbon production operations 300 of FIG. 3 is input data provided to an ensemble model. Additionally, in some embodiments, the bit wear predictions are used to manage the position of the drill string assembly 406 of FIG. 4 during drilling operations. The process 200 can be implemented by the controller 500 of FIG. 5.

At block 202, input data from a target well is input to an ensemble model in real-time.

At block 204, at least one physics-based model and at least one trained artificial intelligence model are applied to the input data to generate bit wear predictions.

At block 206, a collective voting scheme is applied to the bit wear predictions to obtain a final bit wear prediction.

At block 208, a target well is drilled responsive to the final bit wear prediction. In examples, if the bit wear prediction indicates a worn bit at a respective depth, the drill bit can be removed and replaced at the indicated depth, such as when drilling the target well. Accordingly, the bit wear predictions are used to manage the position of the drill string assembly 406 (FIG. 4) during drilling operations, where the drill string and drill bit are removed to replace the drill bit when the bit wear prediction indicates the drill bit is worn. In examples, drilling operations are updated responsive to the final bit wear prediction. The final bit wear prediction enables a more accurate determination of when to replace a drill bit. In examples, the final bit wear prediction is visualized at input/output devices 560 of FIG. 5, such as a display. In examples, the final bit wear prediction provides guidance to a rig crew.

FIG. 3 illustrates hydrocarbon production operations 300 that include both one or more field operations 310 and one or more computational operations 312, which exchange information and control exploration for the production of hydrocarbons. In some implementations, outputs of techniques of the present disclosure can be performed before, during, or in combination with the hydrocarbon production operations 300, specifically, for example, either as field operations 310 or computational operations 312, or both.

Examples of field operations 310 include forming/drilling a wellbore, hydraulic fracturing, producing through the wellbore, injecting fluids (such as water) through the wellbore, to name a few. In some implementations, methods of the present disclosure can trigger or control the field operations 310. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 310 and responsively triggering the field operations 310 including, for example, generating plans and signals that provide feedback to and control physical components of the field operations 310. Alternatively or in addition, the field operations 310 can trigger the methods of the present disclosure. For example, implementing physical components (including, for example, hardware, such as sensors) deployed in the field operations 310 can generate plans and signals that can be provided as input or feedback (or both) to the methods of the present disclosure.

Examples of computational operations 312 include one or more computer systems 320 that include one or more processors and computer-readable media (e.g., non-transitory computer-readable media) operatively coupled to the one or more processors to execute computer operations to perform the methods of the present disclosure. The computational operations 312 can be implemented using one or more databases 318, which store data received from the field operations 310 and/or generated internally within the computational operations 312 (e.g., by implementing the methods of the present disclosure) or both. For example, the one or more computer systems 320 process inputs from the field operations 310 to assess conditions in the physical world, the outputs of which are stored in the databases 318. For example, seismic sensors of the field operations 310 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 312 where they are stored in the databases 318 and analyzed by the one or more computer systems 320.

In some implementations, one or more outputs 322 generated by the one or more computer systems 320 can be provided as feedback/input to the field operations 310 (either as direct input or stored in the databases 318). The field operations 310 can use the feedback/input to control physical components used to perform the field operations 310 in the real world.

For example, the computational operations 312 can process the seismic data to generate three-dimensional (3D) maps of the subsurface formation. The computational operations 312 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 312 to process new information about the formation and control the drilling to adjust to the observed conditions in real-time.

The one or more computer systems 320 can update the 3D maps of the subsurface formation as information from one exploration well is received and the computational operations 312 can adjust the location of the next exploration well based on the updated 3D maps. Similarly, the data received from production operations can be used by the computational operations 312 to control components of the production operations. For example, production well and pipeline data can be analyzed to predict slugging in pipelines leading to a refinery and the computational operations 312 can control machine operated valves upstream of the refinery to reduce the likelihood of plant disruptions that run the risk of taking the plant offline.

In some implementations of the computational operations 312, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

In some embodiments, the one or more field operations 310 and one or more computational operations 312 controls drilling tools and equipment for performing drilling actions in a wellbore. Some components of an example drilling system are shown in FIG. 4. Among other components, the drilling system 312 can include a drilling rig, a drill string, and a bottomhole assembly (BHA). The BHA includes tools for tools that are attached to the end of the drill string that are used for drilling, coring, and logging operations.

FIG. 4 is a partial schematic perspective view of an example rig system 400 for drilling and producing a well. The well can extend from the surface through the Earth to one or more subterranean zones of interest. The example rig system 400 includes a drill floor 402 positioned above the surface, a wellhead 404, a drill string assembly 406 supported by the rig structure, a fluid circulation system 408 to filter used drilling fluid from the wellbore and provide clean drilling fluid to the drill string assembly 406. For example, the example rig system 400 of FIG. 4 is shown as a drill rig capable of performing a drilling operation with the rig system 400 supporting the drill string assembly 406 over a wellbore. The wellhead 404 can be used to support casing or other well components or equipment into the wellbore of the well.

The derrick or mast is a support framework mounted on the drill floor 402 and positioned over the wellbore to support the components of the drill string assembly 406 during drilling operations. A crown block 412 forms a longitudinally-fixed top of the derrick, and connects to a travelling block 414 with a drilling line including a set of wire ropes or cables. The crown block 412 and the travelling block 414 support the drill string assembly 406 via a swivel 416, a kelly 418, or a top drive system (not shown). Longitudinal movement of the travelling block 414 relative to the crown block 412 of the drill string assembly 406 acts to move the drill string assembly 406 longitudinally upward and downward. The swivel 416, connected to and hung by the travelling block 414 and a rotary hook, allows free rotation of the drill string assembly 406 and provides a connection to a kelly hose 420, which is a hose that flows drilling fluid from a drilling fluid supply of the circulation system 408 to the drill string assembly 406. A standpipe 422 mounted on the drill floor 402 guides at least a portion of the kelly hose 420 to a location proximate to the drill string assembly 406. The kelly 418 is a hexagonal device suspended from the swivel 416 and connected to a longitudinal top of the drill string assembly 406, and the kelly 418 turns with the drill string assembly 406 as the rotary table 442 of the drill string assembly turns.

In the example rig system 400 of FIG. 4, the drill string assembly 406 is made up of drill pipes with a drill bit (not shown) at a longitudinally bottom end of the drill string. The drill pipe can include hollow steel piping, and the drill bit can include cutting tools, such as blades, discs, rollers, cutters, or a combination of these, to cut into the formation and form the wellbore. The drill bit rotates and penetrates through rock formations below the surface under the combined effect of axial load and rotation of the drill string assembly 406. In some implementations, the kelly 418 and swivel 416 can be replaced by a top drive that allows the drill string assembly 406 to spin and drill. The wellhead assembly 404 can also include a drawworks 424 and a deadline anchor 426, where the drawworks 424 includes a winch that acts as a hoisting system to reel the drilling line in and out to raise and lower the drill string assembly 406 by a fast line 425. The deadline anchor 426 fixes the drilling line opposite the drawworks 424 by a deadline 427, and can measure the suspended load (or hook load) on the rotary hook. The WOB can be measured when the drill bit is at the bottom the wellbore. The wellhead assembly 404 also includes a blowout preventer 450 positioned at the surface of the well and below (but often connected to) the drill floor 402. The blowout preventer 450 acts to prevent well blowouts caused by formation fluid entering the wellbore, displacing drilling fluid, and flowing to the surface at a pressure greater than atmospheric pressure. The blowout preventer 450 can close around (and in some instances, through) the drill string assembly 406 and seal off the space between the drill string and the wellbore wall.

During a drilling operation of the well, the circulation system 408 circulates drilling fluid from the wellbore to the drill string assembly 406, filters used drilling fluid from the wellbore, and provides clean drilling fluid to the drill string assembly 406. The example circulation system 408 includes a fluid pump 430 that fluidly connects to and provides drilling fluid to drill string assembly 406 via the kelly hose 420 and the standpipe 422. The circulation system 408 also includes a flow-out line 432, a shale shaker 434, a settling pit 436, and a suction pit 438. In a drilling operation, the circulation system 408 pumps drilling fluid from the surface, through the drill string assembly 406, out the drill bit and back up the annulus of the wellbore, where the annulus is the space between the drill pipe and the formation or casing. The density of the drilling fluid is intended to be greater than the formation pressures to prevent formation fluids from entering the annulus and flowing to the surface and less than the mechanical strength of the formation, as a greater density may fracture the formation, thereby creating a path for the drilling fluids to go into the formation. Apart from well control, drilling fluids can also cool the drill bit and lift rock cuttings from the drilled formation up the annulus and to the surface to be filtered out and treated before it is pumped down the drill string assembly 406 again. The drilling fluid returns in the annulus with rock cuttings and flows out to the flow-out line 432, which connects to and provides the fluid to the shale shaker 434. The flow line is an inclined pipe that directs the drilling fluid from the annulus to the shale shaker 434. The shale shaker 434 includes a mesh-like surface to separate the coarse rock cuttings from the drilling fluid, and finer rock cuttings and drilling fluid then go through the settling pit 436 to the suction pit 436. The circulation system 408 includes a mud hopper 440 into which materials (for example, to provide dispersion, rapid hydration, and uniform mixing) can be introduced to the circulation system 408. The fluid pump 430 cycles the drilling fluid up the standpipe 422 through the swivel 416 and back into the drill string assembly 406 to go back into the well.

The example wellhead assembly 404 can take a variety of forms and include a number of different components. For example, the wellhead assembly 404 can include additional or different components than the example shown in FIG. 4. Similarly, the circulation system 408 can include additional or different components than the example shown in FIG. 4.

FIG. 5 is a schematic illustration of an example controller 500 (or control system) for that enables training an artificial intelligence model to predict bit wear. For example, the controller 500 may be operable according to the workflow 100 of FIG. 1 or the process 200 of FIG. 2. In some embodiments, the controller 500 is the same as or similar to the computer systems 320 of FIG. 3. The controller 500 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output interface 540 communicatively coupled with input/output devices 560 (for example, displays, keyboards, measurement devices, sensors, valves, pumps). Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output interface 540.

The memory 520 stores information within the controller 500. In one implementation, the memory 520 is a computer-readable medium. In one implementation, the memory 520 is a volatile memory unit. In another implementation, the memory 520 is a nonvolatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output interface 540 provides input/output operations for the controller 500. In one implementation, the input/output devices 560 includes a keyboard and/or pointing device. In another implementation, the input/output devices 560 includes a display unit for displaying graphical user interfaces.

There can be any number of controllers 500 associated with, or external to, a computer system containing controller 500, with each controller 500 communicating over a network. Further, the terms “client,” “user,” and other appropriate terminology can be used interchangeably, as appropriate, without departing from the scope of the present disclosure. Moreover, the present disclosure contemplates that many users can use one controller 500 and one user can use multiple controllers 500.

### EMBODIMENTS

According to some non-limiting embodiments or examples, provided is a computer-implemented method that enables collective voting from an ensemble model to predict bit wear, including: obtaining input data from a target well in real-time by an ensemble model; applying at least one physics-based model and at least one trained artificial intelligence model to the input data to generate bit wear predictions; applying a collective voting scheme to the bit wear predictions to obtain a final bit wear prediction; and drilling a target well responsive to the final bit wear prediction.

According to some non-limiting embodiments or examples, provided is an apparatus including a non-transitory, computer readable, storage medium that stores instructions that, when executed by at least one processor, cause the at least one processor to perform operations including: obtaining input data from a target well in real-time by an ensemble model; applying at least one physics-based model and at least one trained artificial intelligence model to the input data to generate bit wear predictions; applying a collective voting scheme to the bit wear predictions to obtain a final bit wear prediction; and drilling a target well responsive to the final bit wear prediction.

According to some non-limiting embodiments or examples, provided is a system, including: one or more memory modules; one or more hardware processors communicably coupled to the one or more memory modules, the one or more hardware processors configured to execute instructions stored on the one or more memory modules to perform operations including: obtaining input data from a target well in real-time by an ensemble model; applying at least one physics-based model and at least one trained artificial intelligence model to the input data to generate bit wear predictions; applying a collective voting scheme to the bit wear predictions to obtain a final bit wear prediction; and drilling a target well responsive to the final bit wear prediction.

Further non-limiting aspects or embodiments are set forth in the following numbered embodiments:

Embodiment 1: A computer-implemented method that enables collective voting from an ensemble model to predict bit wear, including: obtaining input data from a target well in real-time by an ensemble model; applying at least one physics-based model and at least one trained artificial intelligence model to the input data to generate bit wear predictions; applying a collective voting scheme to the bit wear predictions to obtain a final bit wear prediction; and drilling a target well responsive to the final bit wear prediction.

Embodiment 2: The computer implemented method of any preceding embodiment, where the collective voting scheme is an average of the bit wear predictions within a predetermined interval.

Embodiment 3: The computer implemented method of any preceding embodiment, where the collective voting scheme includes adaptively averaging bit wear predictions based on a granularity of respective bit wear predictions.

Embodiment 4: The computer implemented method of any preceding embodiment, where the at least one trained artificial intelligence model is trained using filtered data.

Embodiment 5: The computer implemented method of any preceding embodiment, where the bit wear predictions are weighted prior to applying a collective voting scheme to the bit wear predictions.

Embodiment 6: The computer implemented method of any preceding embodiment, where the input data is preprocessed to transform the input data to a standard data format.

Embodiment 7: The computer implemented method of any preceding embodiment, where the at least one physics-based model is based on a physics-based wear equation.

Embodiment 8: An apparatus including a non-transitory, computer readable, storage medium that stores instructions that, when executed by at least one processor, cause the at least one processor to perform operations including: obtaining input data from a target well in real-time by an ensemble model; applying at least one physics-based model and at least one trained artificial intelligence model to the input data to generate bit wear predictions; applying a collective voting scheme to the bit wear predictions to obtain a final bit wear prediction; and drilling a target well responsive to the final bit wear prediction.

Embodiment 9: The apparatus of any preceding embodiment, where the collective voting scheme is an average of the bit wear predictions within a predetermined interval.

Embodiment 10: The apparatus of any preceding embodiment, where the collective voting scheme includes adaptively averaging bit wear predictions based on a granularity of respective bit wear predictions.

Embodiment 11: The apparatus of any preceding embodiment, where the at least one trained artificial intelligence model is trained using filtered data.

Embodiment 12: The apparatus of any preceding embodiment, where the bit wear predictions are weighted prior to applying a collective voting scheme to the bit wear predictions.

Embodiment 13: The apparatus of any preceding embodiment, where the input data is preprocessed to transform the input data to a standard data format.

Embodiment 14: The apparatus of any preceding embodiment, where the at least one physics-based model is based on a physics-based wear equation.

Embodiment 15: A system, including: one or more memory modules; one or more hardware processors communicably coupled to the one or more memory modules, the one or more hardware processors configured to execute instructions stored on the one or more memory modules to perform operations including: obtaining input data from a target well in real-time by an ensemble model; applying at least one physics-based model and at least one trained artificial intelligence model to the input data to generate bit wear predictions; applying a collective voting scheme to the bit wear predictions to obtain a final bit wear prediction; and drilling a target well responsive to the final bit wear prediction.

Embodiment 16: The system of any preceding embodiment, where the collective voting scheme is an average of the bit wear predictions within a predetermined interval.

Embodiment 17: The system of any preceding embodiment, where the collective voting scheme includes adaptively averaging bit wear predictions based on a granularity of respective bit wear predictions.

Embodiment 18: The system of any preceding embodiment, where the at least one trained artificial intelligence model is trained using filtered data.

Embodiment 19: The system of any preceding embodiment, where the bit wear predictions are weighted prior to applying a collective voting scheme to the bit wear predictions.

Embodiment 20: The system of any preceding embodiment, where the input data is preprocessed to transform the input data to a standard data format.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium. Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables collective voting from an ensemble model to predict bit wear, comprising:
obtaining input data from a target well in real-time by an ensemble model;
applying at least one physics-based model and at least one trained artificial intelligence model to the input data to generate bit wear predictions;
applying a collective voting scheme to the bit wear predictions to obtain a final bit wear prediction; and
drilling a target well responsive to the final bit wear prediction.

2. The computer implemented method of claim 1, wherein the collective voting scheme is an average of the bit wear predictions within a predetermined interval.

3. The computer implemented method of claim 1, wherein the collective voting scheme comprises adaptively averaging bit wear predictions based on a granularity of respective bit wear predictions.

4. The computer implemented method of claim 1, wherein the at least one trained artificial intelligence model is trained using filtered data.

5. The computer implemented method of claim 1, wherein the bit wear predictions are weighted prior to applying a collective voting scheme to the bit wear predictions.

6. The computer implemented method of claim 1, wherein the input data is preprocessed to transform the input data to a standard data format.

7. The computer implemented method of claim 1, wherein the at least one physics-based model is based on a physics-based wear equation.

8. An apparatus comprising a non-transitory, computer readable, storage medium that stores instructions that, when executed by at least one processor, cause the at least one processor to perform operations comprising:
obtaining input data from a target well in real-time by an ensemble model;
applying at least one physics-based model and at least one trained artificial intelligence model to the input data to generate bit wear predictions;
applying a collective voting scheme to the bit wear predictions to obtain a final bit wear prediction; and
drilling a target well responsive to the final bit wear prediction.

9. The apparatus of claim 8, wherein the collective voting scheme is an average of the bit wear predictions within a predetermined interval.

10. The apparatus of claim 8, wherein the collective voting scheme comprises adaptively averaging bit wear predictions based on a granularity of respective bit wear predictions.

11. The apparatus of claim 8, wherein the at least one trained artificial intelligence model is trained using filtered data.

12. The apparatus of claim 8, wherein the bit wear predictions are weighted prior to applying a collective voting scheme to the bit wear predictions.

13. The apparatus of claim 8, wherein the input data is preprocessed to transform the input data to a standard data format.

14. The apparatus of claim 8, wherein the at least one physics-based model is based on a physics-based wear equation.

15. A system, comprising:
one or more memory modules;
one or more hardware processors communicably coupled to the one or more memory modules, the one or more hardware processors configured to execute instructions stored on the one or more memory modules to perform operations comprising:
obtaining input data from a target well in real-time by an ensemble model;
applying at least one physics-based model and at least one trained artificial intelligence model to the input data to generate bit wear predictions;
applying a collective voting scheme to the bit wear predictions to obtain a final bit wear prediction; and
drilling a target well responsive to the final bit wear prediction.

16. The system of claim 15, wherein the collective voting scheme is an average of the bit wear predictions within a predetermined interval.

17. The system of claim 15, wherein the collective voting scheme comprises adaptively averaging bit wear predictions based on a granularity of respective bit wear predictions.

18. The system of claim 15, wherein the at least one trained artificial intelligence model is trained using filtered data.

19. The system of claim 15, wherein the bit wear predictions are weighted prior to applying a collective voting scheme to the bit wear predictions.

20. The system of claim 15, wherein the input data is preprocessed to transform the input data to a standard data format.
